(19) United States
(12) Patent Application Publication
(10) Pub. No.: US 2024/0194997 A1
(43) Pub. Date: Jun. 13, 2024

(54) BATTERY PACK CASE

(71) Applicants: HYUNDAI MOTOR COMPANY, Seoul (KR); KIA CORPORATION, Seoul (KR); SUNGWOO HITECH CO., LTD., Busan (KR)

(72) Inventors: Heung Jun Oh, Suwon-si (KR); Kyungbo Kim, Seongnam-si (KR); ChanHoon Park, Suwon-si (KR); Byung Hag Park, Yongin-si (KR); Jae Heon Lee, Busan (KR)

(73) Assignees: HYUNDAI MOTOR COMPANY, Seoul (KR); KIA CORPORATION, Seoul (KR); SUNGWOO HITECH CO., LTD., Busan (KR)

(21) Appl. No.: 18/238,988

(22) Filed: Aug. 28, 2023

(30) Foreign Application Priority Data
Dec. 7, 2022 (KR) 10-2022-0169516

(51) Int. Cl. H01M 50/242; H01M 50/209; H01M 50/249

(52) U.S. Cl. CPC H01M 50/242; H01M 50/209; H01M 50/249

(57) ABSTRACT

A battery pack case may include: i) a case panel; ii) a case outer frame including at least one aluminum sheet and coupled to edge portions of the case panel; iii) a case inner frame including at least one aluminum sheet and coupled to the edge portions and an upper surface of the case panel; and iv) a case cover coupled to upper portions of the case outer frame and case inner frame.

### CROSS-REFERENCE TO RELATED APPLICATION

This application claims priority to and the benefit of Korean Patent Application No. 10-2022-0169516 filed in the Korean Intellectual Property Office on Dec. 7, 2022, the entire contents of which are incorporated herein by reference.

### BACKGROUND

### (a) Field of the Disclosure

An embodiment of the present disclosure relates to a battery pack assembly. More particularly, an embodiment of the present disclosure relates to a battery pack case configured to package at least one battery module assembly.

### (b) Description of the Related Art

Recently, the development of electric vehicles has been steadily increasing due to environmental pollution and efforts to develop alternative energy.

An electric vehicle is equipped with a drive motor for driving the vehicle and a high-voltage battery pack assembly for supplying power to the drive motor. The battery pack assembly is an energy source for the drive motor and may supply high-voltage power to the drive motor through an inverter.

The battery pack assembly is typically mounted on a lower part of a vehicle body, for example, a floor panel of an under body of the vehicle. The battery pack assembly includes a battery pack case and at least one battery module assembly mounted inside the battery pack case.

At least one battery module assembly packages a plurality of battery cells inside the battery module case and protects the plurality of battery cells from an external impact or the like.

The battery pack case is a case frame forming a front portion, a rear portion, and a side portion. The battery pack case includes a plurality of extruded aluminum materials. Each of the plurality of extruded aluminum materials is extruded in such a way as to have a complex cross section to reinforce the rigidity of the battery pack case.

Therefore, the weight of the battery pack case is inevitably increased due to the plurality of extruded aluminum materials. As a result, the industry is actively engaged in research and development to secure robust connectivity between the vehicle body and the battery pack case while simultaneously reducing the weight of the battery pack case.

In addition, in the related art, a plurality of aluminum components having a complex cross-section shape are extruded, which may cause a decrease in productivity, and can lead to challenges in ensuring dimensional accuracy of the complex cross-section shape.

Furthermore, the extruded aluminum components are joined by metal inert gas (MIG) welding, while the extruded aluminum components and a case panel are coupled to one another by friction stir welding (FSW).

However, such MIG welding and FSW may cause deterioration and thermal deformation of the extruded aluminum components and the case panel due to the welding heat.

The above information disclosed in the Description of the Related Art section is only to enhance understanding of the background of the disclosure. Therefore, the Description of the Related Art section may contain information that does not form the prior art that is already known in this country to a person having ordinary skill in the art.

### SUMMARY

The present disclosure attempts to provide a battery pack case that enables weight reduction of a battery pack assembly and increases productivity by minimizing the use of extruded aluminum materials.

The present disclosure further attempts to provide a battery pack case capable of reducing the occurrence of defective cross sections and minimizing welding using metal inert gas (MIG) welding and friction stir welding (FSW).

A battery pack case according to an embodiment of the present disclosure includes a case panel and a case outer frame. The case outer frame includes at least one aluminum panel, i.e., sheet and is coupled to edge portions of the case panel. The battery pack case also includes a case inner frame that has at least one aluminum sheet and is coupled to the edge portions and an upper surface of the case panel. The battery pack case also includes a case cover coupled to upper portions of the case outer frame and case inner frame.

In the battery pack case according to an embodiment of the present disclosure, the case outer frame may include a front member assembly coupled to a front edge portion of the case panel. The case outer frame may also include a rear member assembly coupled to a rear edge portion of the case panel and side member assemblies coupled to both side edge portions of the case panel, respectively.

In the battery pack case according to an embodiment of the present disclosure, the case inner frame may include at least one cross member assembly. The one cross member assembly may be coupled to the edge portions and the upper surface of the case panel inside the case outer frame.

In the battery pack case according to an embodiment of the present disclosure, the front member assembly may include a first aluminum sheet welded to the front edge portion of the case panel and press-formed into a set shape. The front member assembly may also include a second aluminum sheet welded to the first aluminum sheet, having at least one first welding hole, and press-formed into a set shape.

In the battery pack case according to an embodiment of the present disclosure, the first aluminum sheet and the second aluminum sheet may be coupled to each other by spot welding.

In the battery pack case according to an embodiment of the present disclosure, the front edge portion of the case panel and the first aluminum sheet may be coupled to each other by spot welding through the at least one first welding hole.

In the battery pack case according to an embodiment of the present disclosure, the front member assembly may have at least one first closed section formed between the first aluminum sheet and the second aluminum sheet.

In the battery pack case according to an embodiment of the present disclosure, the rear member assembly may include a third aluminum sheet welded to the rear edge portion of the case panel and press-formed into a set shape. The rear member assembly may also include a fourth aluminum sheet welded to the third aluminum sheet, having at least one second welding hole, and press-formed into a set shape.

In the battery pack case according to an embodiment of the present disclosure, the third aluminum sheet and the fourth aluminum sheet may be coupled to each other by spot welding.

In the battery pack case according to an embodiment of the present disclosure, the rear edge portion of the case panel and the third aluminum sheet may be coupled to each other by spot welding through the at least one second welding hole.

In the battery pack case according to an embodiment of the present disclosure, the rear member assembly may have at least one second closed section formed between the third aluminum sheet and the fourth aluminum sheet.

In the battery pack case according to an embodiment of the present disclosure, a side member assembly of the side member assemblies may include a fifth aluminum sheet welded to a respective side edge portion of the side edge portions of the case panel and press-formed into a set shape. The side member assembly may also include a sixth aluminum sheet welded to the fifth aluminum sheet, having a plurality of third welding holes, and press-formed into a set shape. Additionally, the side member assembly may include a plurality of bulkheads coupled to the sixth aluminum sheet and press-formed into a set shape.

In the battery pack case according to an embodiment of the present disclosure, each of the both side edge portions of the case panel and the fifth aluminum sheet may be coupled to each other by spot welding.

In the battery pack case according to an embodiment of the present disclosure, the sixth aluminum sheet and the plurality of bulkheads may be coupled to each other by spot welding through the plurality of third welding holes.

In the battery pack case according to an embodiment of the present disclosure, the sixth aluminum sheet may have a first portion oriented in a vertical direction, and a second portion extending from the first portion in a reverse C cross-section shape and having the plurality of third welding holes.

In the battery pack case according to an embodiment of the present disclosure, the side member assembly may have at least one third closed section formed between the fifth aluminum sheet and the first portion when coupled to each other. The side member assembly may also have at least one fourth closed section formed between the fifth aluminum sheet and the second portion when coupled to each other.

In the battery pack case according to an embodiment of the present disclosure, the plurality of bulkheads may be formed of an aluminum material, disposed in the fourth closed section, and coupled to the second portion by spot welding through the plurality of welding holes.

In the battery pack case according to an embodiment of the present disclosure, the at least one cross member assembly may include an extruded aluminum component or material welded to the edge portions and the upper surface of the case panel and extruded into a set shape. The at least one cross member assembly may also include a seventh aluminum sheet welded to the extruded aluminum material and press-formed into a set shape.

In the battery pack case according to an embodiment of the present disclosure, the extruded aluminum component or material may have a rectangular cross-section shape.

In the battery pack case according to an embodiment of the present disclosure, the seventh aluminum sheet may have an “n” cross-section shape in such a way that the extruded aluminum material is positioned inside the seventh aluminum sheet.

In the battery pack case according to an embodiment of the present disclosure, the at least one cross member assembly may have at least one fifth closed section formed inside the extruded aluminum material, and a sixth closed section formed between the extruded aluminum material and the seventh aluminum sheet.

According to embodiments of the present disclosure, it is possible to minimize the occurrence of defective cross sections by minimizing the application of an extruded aluminum material having a relatively complex cross-section shape. It is also possible to increase the degree of freedom in designing a battery pack assembly, reduce the weight of the battery pack assembly, and increase productivity.

Other effects that may be obtained or are predictable by an embodiment of the present disclosure are explicitly or implicitly described in the following detailed description of the present disclosure. In other words, various effects that may be achieved or predictable according to an embodiment are described in the following detailed description.

### BRIEF DESCRIPTION OF THE DRAWINGS

Since the accompanying drawings are provided only to describe the embodiments of the present disclosure, the spirit and scope of the present disclosure should not be limited to or by the accompanying drawings.

FIG. 1 is an assembled perspective view illustrating a battery pack case according to an embodiment of the present disclosure.

FIGS. 2 and 3 are exploded perspective views illustrating the battery pack case according to an embodiment of the present disclosure.

FIG. 4 is a plan view illustrating the battery pack case according to an embodiment of the present disclosure.

FIG. 5 is an assembled perspective view illustrating a portion of a front member assembly applied to the battery pack case according to an embodiment of the present disclosure.

FIG. 6 is an exploded perspective view illustrating the front member assembly applied to the battery pack case according to an embodiment of the present disclosure.

FIG. 7 is a cross-section view illustrating the front member assembly applied to the battery pack case according to an embodiment of the present disclosure.

FIG. 8 is an assembled perspective view illustrating a portion of a rear member assembly applied to the battery pack case according to an embodiment of the present disclosure.

FIG. 9 is an exploded perspective view illustrating the rear member assembly applied to the battery pack case according to an embodiment of the present disclosure.

FIG. 10 is a cross-section view illustrating the rear member assembly applied to the battery pack case according to an embodiment of the present disclosure.

FIG. 11 is an assembled perspective view illustrating a portion of a side member assembly applied to the battery pack case according to an embodiment of the present disclosure.

FIG. 12 is an exploded perspective view illustrating the side member assembly applied to the battery pack case according to an embodiment of the present disclosure.

FIG. 13 is a cross-section view illustrating the side member assembly applied to the battery pack case according to an embodiment of the present disclosure.

FIG. 14 is an assembled perspective view illustrating a portion of a cross member assembly applied to the battery pack case according to an embodiment of the present disclosure.

FIG. 15 is an exploded perspective view illustrating the cross member assembly applied to the battery pack case according to an embodiment of the present disclosure.

FIG. 16 is a cross-section view illustrating the cross member assembly applied to the battery pack case according to an embodiment of the present disclosure.

It should be understood that the drawings referenced above are not necessarily drawn to scale and may present somewhat simplified representations of various features illustrating the basic principles of the present disclosure. Specific design features of the present disclosure as included herein, including, for example, specific dimensions, orientations, locations, and shapes will be determined in part by the particularly intended application and use environment.

### DETAILED DESCRIPTION

The present disclosure is described more fully hereinafter with reference to the accompanying drawings, in which embodiments of the disclosure are shown. As those having ordinary skill in the art should realize, the described embodiments may be modified in various different ways, all without departing from the spirit or scope of the present disclosure.

Terms used herein are for describing particular embodiments and are not intended to limit the present disclosure. As used herein, singular forms are intended to include plural forms as well, unless the context clearly indicates otherwise.

It is to be further understood that the terms “includes” and/or “including” used in the present specification specify the presence of stated features, integers, steps, operations, elements, and/or components, but do not preclude the presence or addition of one or more other features, integers, steps, operations, components, and/or combinations thereof. As used in the present specification, the term “and/or” includes any or all combinations of one or more of the associated listed items.

In the present specification, the term “coupled” indicates a physical relationship between two components, in which the components are directly connected to each other or indirectly connected through one or more intermediate components.

It is to be understood that the terms “vehicle,” “vehicular,” “car,” or another similar terms as used herein is inclusive of motor vehicles in general. Such motor vehicles may encompass passenger automobiles including passenger vehicles, sport utility vehicles (SUVs), buses, trucks, and various commercial vehicles. Such motor vehicles may also include hybrid vehicles, electric vehicles, hybrid electric vehicles, electric vehicle-based purpose built vehicles (PBVs), hydrogen-powered vehicles, and other alternative fuel vehicles (e.g., fuels derived from resources other than petroleum).

Hereinafter, embodiments of the present disclosure are described in detail with reference to the accompanying drawings.

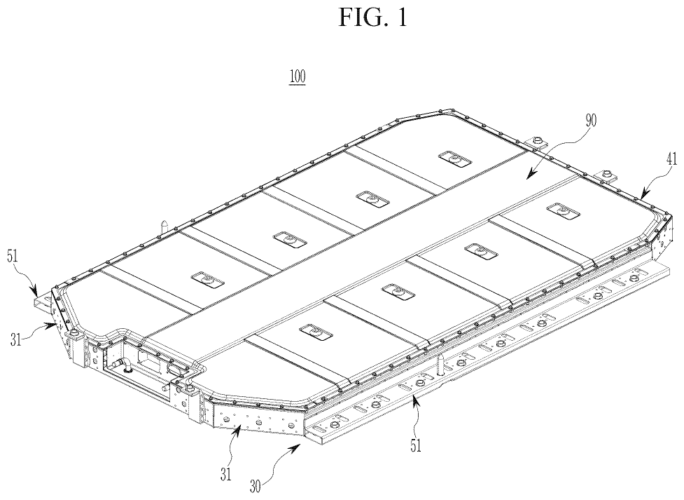

FIG. 1 is an assembled perspective view illustrating a battery pack case according to an embodiment of the present disclosure.

Referring to FIG. 1, a battery pack case 100 according to an embodiment of the present disclosure may be applied to a battery pack assembly mounted on a vehicle body of an eco-friendly vehicle.

The eco-friendly vehicle may include a hybrid vehicle, an electric vehicle, a hydrogen-powered vehicle (commonly referred to as a “hydrogen electric vehicle” by those having ordinary skill in the art), and an electric vehicle-based purpose-built vehicle (PBV).

In one example, the battery pack assembly may be mounted on a vehicle body of an electric vehicle in a process of coupling various parts to the vehicle body. Furthermore, the battery pack assembly may be mounted on a lower part of the vehicle body, e.g., a chassis frame, a rolling chassis, or a skateboard type body structure.

In the present specification, reference directions for describing the following components may be set to a front-rear or lengthwise direction, a side-side or lateral direction, and an up-down or vertical direction based on the drawings.

In addition, in the present specification, the terms “upper end portion,” “upper portion.” “upper end.” or “upper surface” of a component indicate an end portion, portion, end, or surface of the component that is positioned on a relatively upper side in the drawing. Furthermore, the terms “lower end portion,” “lower portion,” “lower end,” or “lower surface” of a component indicate an end portion, portion, end, or surface of the component that is positioned on a relatively lower side in the drawing.

Furthermore, in the present specification, an end of a component (e.g., one end or the other end) refers to an end of the component in any one direction. An end portion of a component (e.g., one end portion or the other end portion) refers to a certain portion of the component that includes an end of the component.

The battery pack case 100 according to an embodiment of the present disclosure is configured in such a way that at least one battery module assembly (not illustrated), in which a plurality of battery cells (not illustrated) may be packaged, is mounted inside the battery pack case 100.

The battery pack case 100 according to an embodiment of the present disclosure has a structure that may promote weight reduction of a battery pack assembly. The structure may also promote productivity improvement by minimizing the use of extruded aluminum material and may reduce the occurrence of defective cross-sections. Additionally, the structure may minimize welding by using metal inert gas (MIG) welding and friction stir welding (FSW).

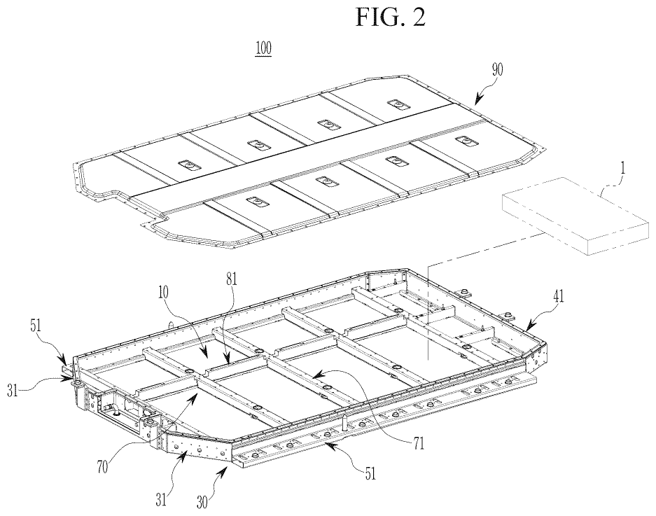

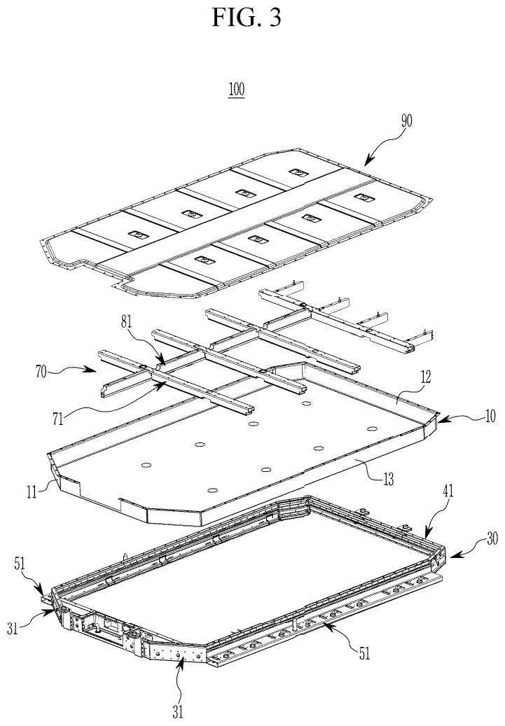

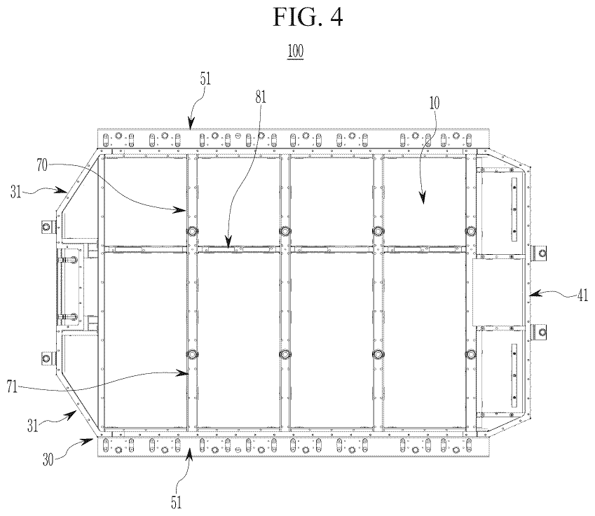

FIGS. 2 and 3 are exploded perspective views illustrating the battery pack case according to an embodiment of the present disclosure. FIG. 4 is a plan view illustrating the battery pack case according to an embodiment of the present disclosure.

Referring to FIGS. 1-4, the battery pack case 100 according to an embodiment of the present disclosure may include a case panel 10, a case outer frame 30, a case inner frame 70, and a case cover 90.

In an embodiment of the present disclosure, the case panel 10 may be provided as a bottom plate of the battery pack case 100. The case panel 10 supports at least one battery module assembly 1 as mentioned above.

The case panel 10 may be manufactured into a set shape by a process of press forming an aluminum blank sheet. Edge portions of the case panel 10, that is, a front edge portion 11, a rear edge portion 12, and both side edge portions 13 may be formed as wall surfaces.

In an embodiment of the present disclosure, the case outer frame 30 may be implemented by a combination (e.g., an assembly structure) of frames coupled to the edge portions of the case panel 10. The case outer frame 30 includes a front member assembly 31, a rear member assembly 41, and side member assemblies 51.

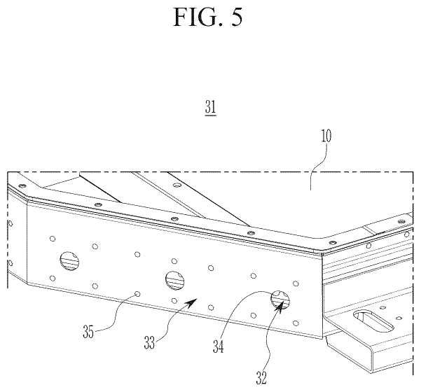

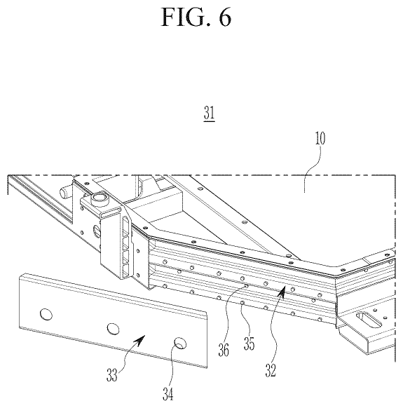

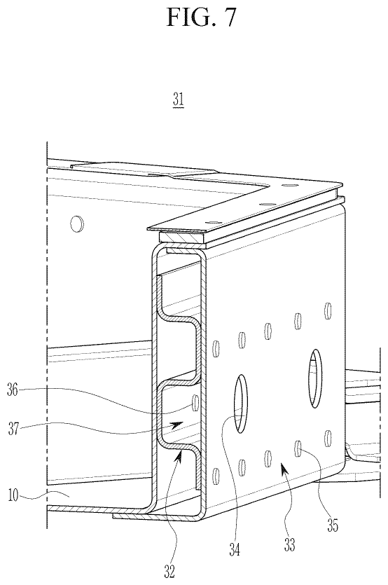

FIG. 5 is an assembled perspective view illustrating a portion of the front member assembly applied to the battery pack case according to an embodiment of the present disclosure. FIG. 6 is an exploded perspective view illustrating the front member assembly applied to the battery pack case according to an embodiment of the present disclosure. FIG. 7 is a cross-section view illustrating the front member assembly applied to the battery pack case according to an embodiment of the present disclosure.

Referring to FIGS. 5-7, the front member assembly 31 according to an embodiment of the present disclosure is coupled to the front edge portion 11 of the case panel 10. The front member assembly 31 includes a first aluminum sheet material 32 and a second aluminum sheet material 33.

The first aluminum sheet, panel, or component 32 may be welded to the front edge portion 11 of the case panel 10. The first aluminum sheet 32 may be manufactured into a set shape by a process of press forming an aluminum blank.

In one example, the first aluminum sheet 32 may be formed to have a zigzag cross-section shape (e.g., wave shape) in a vertical direction.

The second aluminum sheet, panel, or component 33 may be welded to the first aluminum sheet 32. The second aluminum sheet 33 may be manufactured into a set shape by a process of press forming an aluminum blank.

The second aluminum sheet 33 has at least one first welding hole 34.

The first aluminum sheet 32 and the second aluminum sheet 33 may be coupled to each other by spot welding. The first aluminum sheet 32 and the second aluminum sheet 33 may be coupled to each other by a plurality of first spot welding portions 35.

In addition, the front edge portion 11 of the case panel 10 and the first aluminum sheet 32 may be coupled to each other by spot welding through at least one first welding hole 34. The front edge portion 11 of the case panel 10 and the first aluminum sheet 32 may be coupled to each other by a plurality of second spot welding portions 36.

Furthermore, the front member assembly 31 according to an embodiment of the present disclosure has at least one first closed section 37. The at least one first closed section 37 may be formed between the first aluminum sheet 32 and the second aluminum sheet 33 when coupled to each other. The at least one first closed section 37 may be formed by the first aluminum sheet 32 having a zigzag cross-section shape as depicted in FIG. 7.

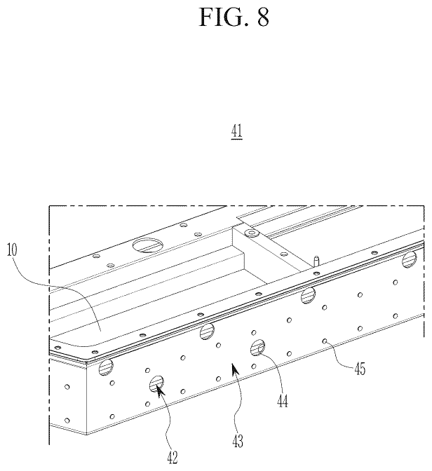

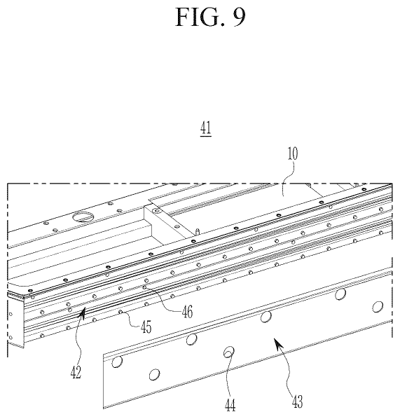

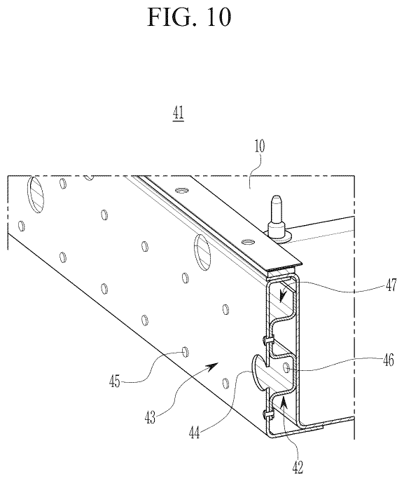

FIG. 8 is an assembled perspective view illustrating the rear member assembly applied to the battery pack case according to an embodiment of the present disclosure. FIG. 9 is an exploded perspective view illustrating the rear member assembly applied to the battery pack case according to an embodiment of the present disclosure. FIG. 10 is a cross-section view illustrating the rear member assembly applied to the battery pack case according to an embodiment of the present disclosure.

Referring to FIGS. 8-10, the rear member assembly 41 according to an embodiment of the present disclosure is coupled to the rear edge portion 12 of the case panel 10. The rear member assembly 41 includes a third aluminum sheet, panel, or component 42 and a fourth aluminum sheet, panel, or component 43.

The third aluminum sheet 42 may be welded to the rear edge portion 12 of the case panel 10. The third aluminum sheet 42 may be manufactured into a set shape by a process of press forming an aluminum blank.

In one example, the third aluminum sheet 42 may be formed to have a zigzag cross-section shape (or wave shape) in the vertical direction.

The fourth aluminum sheet 43 may be welded to the third aluminum sheet 42. The fourth aluminum sheet 43 may be manufactured into a set shape by a process of press forming an aluminum blank.

The fourth aluminum sheet 43 has at least one second welding hole 44.

The third aluminum sheet 42 and the fourth aluminum sheet 43 may be coupled to each other by spot welding. The third aluminum sheet 42 and the fourth aluminum sheet 43 may be coupled to each other by a plurality of third spot welding portions 45.

In addition, the rear edge portion 12 of the case panel 10 and the third aluminum sheet 42 may be coupled to each other by spot welding through at least one second welding hole 44. The rear edge portion 12 of the case panel 10 and the third aluminum sheet 42 may be coupled to each other by a plurality of fourth spot welding portions 46.

Furthermore, the rear member assembly 41 according to an embodiment of the present disclosure has at least one second closed section 47.

The at least one second closed section 47 may be formed between the third aluminum sheet 42 and the fourth aluminum sheet 43 when coupled to each other. The at least one second closed section 47 may be formed by the third aluminum sheet 42 having a zigzag cross-section shape, as depicted in FIG. 10.

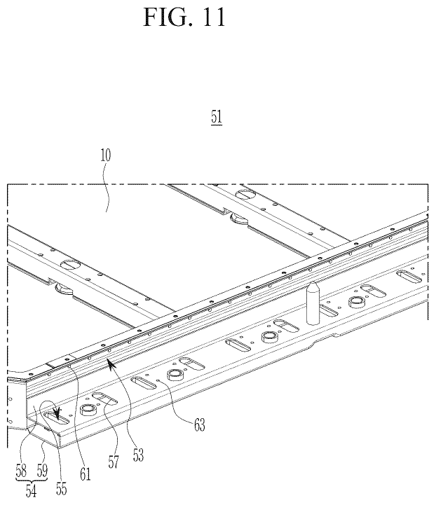

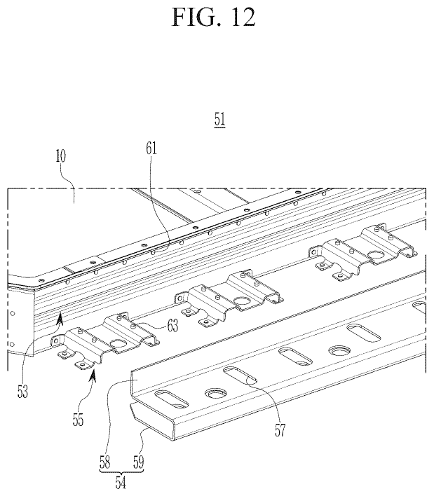

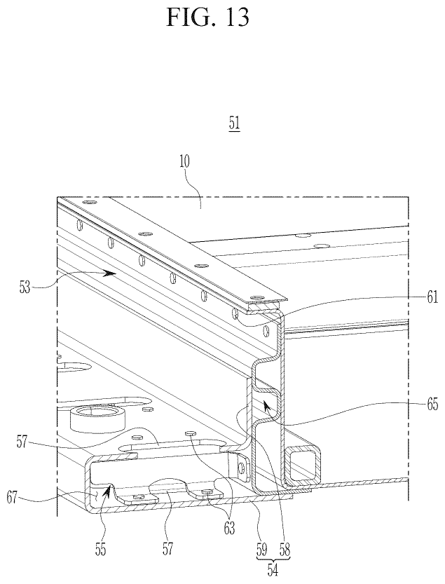

FIG. 11 is an assembled perspective view illustrating a portion of one of the side member assemblies applied to the battery pack case according to an embodiment of the present disclosure. FIG. 12 is an exploded perspective view illustrating the side member assembly applied to the battery pack case according to an embodiment of the present disclosure. FIG. 13 is a cross-section view illustrating the side member assembly applied to the battery pack case according to an embodiment of the present disclosure.

Referring to FIGS. 11-13, the side member assemblies 51 according to an embodiment of the present disclosure are coupled to both side edge 13 portions of the case panel 10, respectively. Each side member assembly 51 includes a fifth aluminum sheet, panel, or component 53, a sixth aluminum sheet, panel, or component 54, and a plurality of bulkheads 55.

Each fifth aluminum sheet 53 may be welded to each of the side edge portions 13 of the case panel 10. The fifth aluminum sheet 53 may be manufactured into a set shape by a process of press forming an aluminum blank.

In one example, the fifth aluminum sheet 53 may be formed to have a zigzag cross-section shape (e.g., wave shape) in the vertical direction.

The sixth aluminum sheet 54 may be welded to the fifth aluminum sheet 53. The sixth aluminum sheet 54 may be manufactured into a set shape by a process of press forming an aluminum blank.

The sixth aluminum sheet 54 has a plurality of third welding holes 57.

Furthermore, the sixth aluminum sheet 54, as described above, has a flange-type first portion 58 formed to extend or be oriented in the vertical direction. Additionally, the sixth aluminum sheet 54 has a second portion 59 extending from the first portion 58 in a reverse C cross-section shape.

The first portion 58 may extend upward from an upper portion of the second portion 59. Further, the plurality of third welding holes 57, as mentioned above, are formed in each of the upper and lower portions of the second portion 59.

Both side edge portions 13 of the case panel 10 and respective fifth aluminum sheets 53 may be coupled to each other by spot welding. Both side edge portions 13 of the case panel 10 and the respective fifth aluminum sheets 53 may be coupled to each other by a plurality of fifth spot welding portions 61.

The plurality of bulkheads 55, as described above, may be welded to the sixth aluminum sheet 54. The plurality of bulkheads 55 are designed to reinforce the rigidity of the sixth aluminum sheet 54. Such a plurality of bulkheads 55 may be manufactured into a set shape by a process of press forming an aluminum blank.

The plurality of bulkheads 55 may be inserted into the second portion 59 of the sixth aluminum sheet 54 and welded to the second portion 59 by spot welding through the plurality of third welding holes 57. The plurality of bulkheads 55 and the second portion 59 may be coupled to each other by a plurality of sixth spot welding portions 63.

Further, the first portion 58 and the second portion 59 of the sixth aluminum sheet 54 to which the plurality of bulkheads 55 are coupled, may be welded to the fifth aluminum sheet 53. For example, the fifth aluminum sheet 53 and the first portion 58 and the second portion 59 of the sixth aluminum sheet 54 may be coupled to each other by MIG welding.

Furthermore, each side member assembly 51 according to an embodiment of the present disclosure has at least one third closed section 65 and at least one fourth closed section 67.

The at least one third closed section 65 may be formed between the fifth aluminum sheet 53 and the first portion 58 of the sixth aluminum sheet 54 when coupled to each other. The at least one third closed section 65 may be formed by the fifth aluminum sheet material 53 having a zigzag cross-section shape.

The at least one fourth closed section 67 may be formed between the fifth aluminum sheet 53 and the second portion 59 of the sixth aluminum sheet 54 when coupled to each other. The plurality of bulkheads 55, as described above, may be disposed in the fourth closed section 67.

Referring to FIGS. 2-4, according to an embodiment of the present disclosure, the case inner frame 70 may be implemented by a combination (e.g., an assembly structure) of frames, which are coupled to the edge portions and an upper surface of the case panel 10.

The case inner frame 70 includes at least one cross member assembly 71.

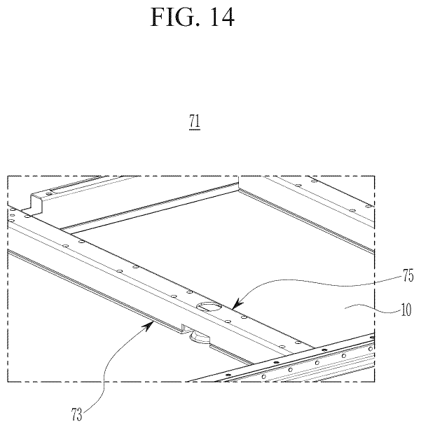

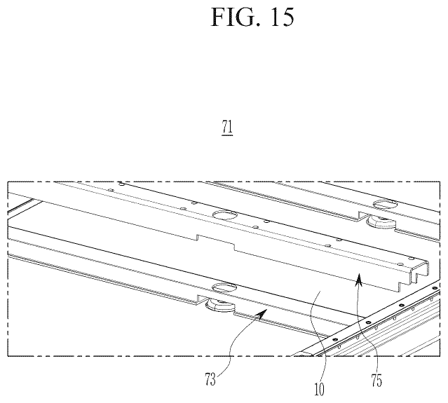

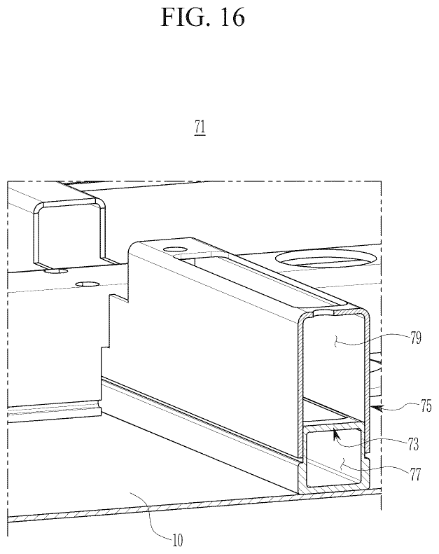

FIG. 14 is an assembled perspective view illustrating the cross member assembly applied to the battery pack case according to an embodiment of the present disclosure. FIG. 15 is an exploded perspective view illustrating the cross member assembly applied to the battery pack case according to an embodiment of the present disclosure. FIG. 16 is a cross-section view illustrating the cross member assembly applied to the battery pack case according to an embodiment of the present disclosure.

Referring to FIGS. 14-16, the at least one cross member assembly 71 according to an embodiment of the present disclosure is configured in such a way as to mount at least one battery module assembly 1 on the upper surface of the case panel 10. The at least one cross member assembly 71 may be provided as a transverse member assembly, which is disposed in a transverse direction on the upper surface of the case panel 10.

The at least one cross member assembly 71 is coupled to the edge portions and the upper surface of the case panel 10 inside the case outer frame 30. The at least one cross member assembly 71 includes an extruded aluminum component or material 73 and a seventh aluminum sheet 75.

The extruded aluminum material 73 may be welded to the edge portions (e.g., inner surfaces of the edge portions of the case panel 10) and the upper surface of the case panel 10. The extruded aluminum material 73 may be manufactured into a set beam shape by a process of extruding an aluminum material.

In one example, the extruded aluminum material 73 may have a rectangular cross-section shape (e.g., a closed cross-section shape). In addition, the extruded aluminum material 73 may be coupled to the inner surfaces of the edge portions and the upper surface of the case panel 10 by MIG welding.

The seventh aluminum sheet 75 may be manufactured into a set shape by a process of press forming an aluminum blank. The seventh aluminum sheet 75 may be welded to the extruded aluminum material 73. The seventh aluminum sheet 75 may be coupled to the inner surfaces of the edge portions of the case panel 10 and the surfaces (e.g., the upper and side surfaces) of the extruded aluminum material 73 by MIG welding.

Such a seventh aluminum sheet 75 may be provided in an “n” cross-section shape in such a way that the extruded aluminum material 73 is positioned inside the seventh aluminum sheet 75.

Furthermore, the at least one cross member assembly 71 according to an embodiment of the present disclosure has at least one fifth closed section 77 and at least one sixth closed section 79.

The at least one fifth closed section 77 may be formed in a quadrangular shape inside the extruded aluminum material 73. The one sixth closed section 79 may be formed in a rectangular shape between the extruded aluminum material 73 and the seventh aluminum sheet 75 when coupled to each other.

Referring to FIGS. 2-4, the case inner frame 70 according to an embodiment of the present disclosure may include at least one longitudinal member assembly 81 coupled to at least one cross member assembly 71.

The longitudinal member assembly 81 may be disposed in a direction (e.g., a longitudinal or lengthwise direction) intersecting at least one cross member assembly 71 on the upper surface of the case panel 10.

Similar to the at least one cross member assembly 71, the longitudinal member assembly 81 may be implemented by a combination of an extruded aluminum component or material and an aluminum sheet, panel, or component. In addition, the longitudinal member assembly 81 may be coupled to the inner surfaces of the edge portions of the case panel 10, the upper surface of the case panel 10, and at least one cross member assembly 71 by MIG welding.

Referring to FIGS. 1-3, according to an embodiment of the present disclosure, the case cover 90 closes an upper portion of the case panel 10. The case panel 90 may be manufactured into a set shape by a process of press forming an aluminum blank. The case cover 90 is coupled to the upper portions of the case outer frame 30 and the case inner frame 70.

The case cover 90 may be fastened to the upper portions of the case outer frame 30 and the case inner frame 70 by a fastening member implemented by, for example, a combination of bolts and nuts.

Hereinafter, an assembly process and operation for the battery pack case 100, configured as described above in an embodiment of the present disclosure, is described in detail with reference to FIGS. 1-16.

First, according to an embodiment of the present disclosure, the case panel 10 Is provided, having been manufactured into a set shape by a process of press forming an aluminum blank. Then, the case cover 90 is provided, having been manufactured into a set shape by a process of press forming an aluminum blank.

The case outer frame 30 includes the front member assembly 31, the rear member assembly 41, and the side member assemblies 51 that are coupled to the edge portions of the case panel 10, respectively.

An assembly process for the case outer frame 30 is described in detail below. First, the first aluminum sheet 32 and the second aluminum sheet 33 of the front member assembly 31 are coupled to each other by spot welding. Then, the front edge portion 11 of the case panel 10 and the first aluminum sheet 32 are coupled to each other by spot welding. In the front member assembly 31, at least one first closed section 37 is formed between the first aluminum sheet 32 and the second aluminum sheet 33 when coupled to each other.

Second, the third aluminum sheet 42 and the fourth aluminum sheet 43 of the rear member assembly 41 are coupled to each other by spot welding. The rear edge portion 12 of the case panel 10 and the third aluminum sheet 42 are coupled to each other by spot welding. In the rear member assembly 41, at least one second closed section 47 is formed between the third aluminum sheet 42 and the fourth aluminum sheet 43 when coupled to each other.

Third, in each side member assembly 51, the fifth aluminum sheet 53 is coupled to a respective side edge portion 13 of the case panel 10 by spot welding. Then, the plurality of bulkheads 55 are inserted into the second portion 59 of the sixth aluminum sheet 54 and coupled to the second portion 59 by spot welding. Furthermore, the first portion 58 and the second portion 59 of the sixth aluminum sheet 54 are coupled to the fifth aluminum sheet 53 by MIG welding. In each side member assembly 51, at least one third closed section 65 is formed between the fifth aluminum sheet 53 and the first portion 58 of the sixth aluminum sheet 54 when coupled to each other. Further, in each side member assembly 51, the fourth closed section 67 is formed between the fifth aluminum sheet 53 and the second portion 59 of the sixth aluminum sheet 54 when coupled to each other.

As described above, in a state where the case outer frame 30 is coupled to the edge portions of the case panel 10, the case inner frame 70 including at least one cross member assembly 71 is coupled to the edge portions and the upper surface of the case panel 10.

An assembly process for the case inner frame 70 is described in detail below. The extruded aluminum material 73 of at least one cross member assembly 71 is coupled to the inner surfaces of the edge portions of the case panel 10 and the upper surface of the case panel 10 by MIG welding. Then, the seventh aluminum sheet 75 is coupled to the inner surfaces of the edge portions of the case panel 10 and the extruded aluminum component or material 73 by MIG welding. In at least one cross member assembly 71, at least one fifth closed section 77 is formed inside the extruded aluminum material 73. In addition, in the at least one cross member assembly 71, the sixth closed section 79 is formed between the extruded aluminum material 73 and the seventh aluminum sheet 75 when coupled to each other.

The battery pack case 100 according to an embodiment of the present disclosure may be assembled through a series of processes as described above.

In the battery pack case 100 according to an embodiment of the present disclosure, at least one battery module assembly 1 is disposed on the upper surface of the case panel 10. The at least one battery module assembly 1 may be mounted on at least one cross member assembly 71.

Then, a battery pack assembly in which at least one battery module assembly 1 is packaged inside the battery pack case 100 according to an embodiment of the present disclosure may be provided by coupling the case cover 90 to the upper portions of the case outer frame 30 and the case inner frame 70.

The battery pack case 100 according to an embodiment of the present disclosure as described above includes the case outer frame 30 and the case inner frame 70 formed using an aluminum sheet, panel, or component or a combination of an aluminum sheet and an extruded aluminum component or material.

Therefore, with the battery pack case 100 according to an embodiment of the present disclosure, it is possible to minimize the occurrence of defective cross sections by minimizing the application of an extruded aluminum material having a relatively complex cross-section shape. Furthermore, it is possible to increase the degree of freedom in designing the battery pack assembly, reduce the weight of the battery pack assembly, and increase productivity.

In addition, in the battery pack case 100 according to an embodiment of the present disclosure, an aluminum sheet material having a yield strength and a tensile strength that are 20% higher than those of an extruded aluminum material is applied to the case outer frame 30 and the case inner frame 70. The closed sections are formed inside the case outer frame 30 and the case inner frame 70.

Accordingly, the battery pack case 100 according to an embodiment of the present disclosure may secure the rigidity and connection robustness of the case outer frame 30 and the case inner frame 70. Thus, an impact resistance of the battery pack assembly may be further improved.

Furthermore, in the battery pack case 100 according to an embodiment of the present disclosure, spot welding is mainly applied as an assembly (e.g., bonding) method for the case outer frame 30 and the case inner frame 70.

Therefore, the battery pack case 100 according to an embodiment of the present disclosure may minimize welding using MIG welding and FSW according to the related art. As a result, deterioration and thermal deformation of the case outer frame 30 and the case inner frame 70 may be reduced.

Although embodiments of the present disclosure have been described above, the present disclosure is not limited thereto. It is possible to carry out various modifications within the scope of the claims, the detailed description of the present disclosure, and the accompanying drawings. Thus, it should be apparent that the modifications fall within the scope of the present disclosure.

<Description of symbols>

| | |
|---|---|
| 1: battery module assembly | 10: case panel |
| 30: case outer frame | 31: front member assembly |
| 32: first aluminum sheet | 33: second aluminum sheet |
| 34: first welding hole | 35: first spot welding portion |
| 36: second spot welding portion | 37: first closed section |
| 41: rear member assembly | 42: third aluminum sheet |
| 43: fourth aluminum sheetl | 44: second welding hole |
| 45: third spot welding portion | 46: fourth spot welding portion |
| 47: second closed section | 51: side member assembly |
| 53: fifth aluminum sheet | 54: sixth aluminum sheet |
| 55: bulkhead | 57: third welding hole |
| 58: first portion | 59: second portion |
| 61: fifth spot welding portion | 63: sixth spot welding portion |
| 65: third closed section | 67: fourth closed section |
| 70: case inner frame | 71: cross member assembly |
| 73: extruded aluminum material | 75: seventh aluminum sheet |
| 77: fifth closed section | 79: sixth closed section |
| 81: longitudinal member assembly | 100: battery pack case |
| 90: case cover | |

What is claimed is:

1. A battery pack case comprising:
a case panel;
a case outer frame including at least one aluminum sheet and coupled to edge portions of the case panel;
a case inner frame including at least one aluminum sheet and coupled to the edge portions and an upper surface of the case panel; and
a case cover coupled to upper portions of the case outer frame and case inner frame.

2. The battery pack case of claim 1, wherein the case outer frame includes
a front member assembly coupled to a front edge portion of the case panel,
a rear member assembly coupled to a rear edge portion of the case panel, and
side member assemblies coupled to both side edge portions of the case panel, respectively.

3. The battery pack case of claim 2, wherein the case inner frame includes at least one cross member assembly coupled to the edge portions and the upper surface of the case panel inside the case outer frame.

4. The battery pack case of claim 2, wherein the front member assembly includes
a first aluminum sheet welded to the front edge portion of the case panel and press-formed into a set shape, and
a second aluminum sheet welded to the first aluminum sheet, having at least one first welding hole, and press-formed into a set shape.

5. The battery pack case of claim 4, wherein
the first aluminum sheet and the second aluminum sheet are coupled to each other by spot welding, and
the front edge portion of the case panel and the first aluminum sheet are coupled to each other by spot welding through the at least one first welding hole.

6. The battery pack case of claim 4, wherein the front member assembly has at least one first closed section formed between the first aluminum sheet and the second aluminum sheet.

7. The battery pack case of claim 2, wherein the rear member assembly includes
a third aluminum sheet welded to the rear edge portion of the case panel and press-formed into a set shape, and
a fourth aluminum sheet welded to the third aluminum sheet, having at least one second welding hole, and press-formed into a set shape.

8. The battery pack case of claim 7, wherein
the third aluminum sheet and the fourth aluminum sheet are coupled to each other by spot welding, and
the rear edge portion of the case panel and the third aluminum sheet are coupled to each other by spot welding through the at least one second welding hole.

9. The battery pack case of claim 7, wherein the rear member assembly has at least one second closed section formed between the third aluminum sheet and the fourth aluminum sheet.

10. The battery pack case of claim 2, wherein each side member assembly of the side member assemblies includes
a fifth aluminum sheet welded to each of the side edge portions of the case panel and press-formed into a set shape,
a sixth aluminum sheet welded to the fifth aluminum sheet, having a plurality of third welding holes, and press-formed into a set shape, and
a plurality of bulkheads coupled to the sixth aluminum sheet and press-formed into a set shape.

11. The battery pack case of claim 10, wherein
each of the side edge portions of the case panel and the fifth aluminum sheet are coupled to each other by spot welding, and
the sixth aluminum sheet and the plurality of bulkheads are coupled to each other by spot welding through the plurality of third welding holes.

12. The battery pack case of claim 10, wherein the sixth aluminum sheet has
a first portion oriented in a vertical direction, and
a second portion extending from the first portion in a reverse C cross-section shape and having the plurality of third welding holes.

13. The battery pack case of claim 12, wherein the side member assembly has
at least one third closed section formed between the fifth aluminum sheet and the first portion when coupled to each other, and
at least one fourth closed section formed between the fifth aluminum sheet and the second portion when coupled to each other.

14. The battery pack case of claim 13, wherein the plurality of bulkheads is formed of an aluminum material, disposed in the fourth closed section, and coupled to the second portion by spot welding through the plurality of third welding holes.

15. The battery pack case of claim 3, wherein the at least one cross member assembly includes
an extruded aluminum material welded to the edge portions and the upper surface of the case panel and extruded into a set shape, and
a seventh aluminum sheet welded to the extruded aluminum material and press-formed into a set shape.

16. The battery pack case of claim 15, wherein
the extruded aluminum material has a rectangular cross-section shape, and
the seventh aluminum sheet has an “n” cross-section shape in such a way that the extruded aluminum material is positioned inside the seventh aluminum sheet.

17. The battery pack case of claim 16, wherein the at least one cross member assembly has
at least one fifth closed section formed inside the extruded aluminum material, and
a sixth closed section formed between the extruded aluminum material and the seventh aluminum sheet.
